(19) United States
(12) Patent Application Publication
(10) Pub. No.: US 2008/0190774 A1
(43) Pub. Date: Aug. 14, 2008

(54) Silver Ion Water Generating Apparatus

(76) Inventor: Young Chul Choi, Incheon (KR)

Correspondence Address: SCHMEISER OLSEN & WATTS, 18 E UNIVERSITY DRIVE, SUITE # 101, MESA, AZ, 85201, US

(21) Appl. No.: 11/910,424

(22) PCT Filed: Mar. 31, 2006
(86) PCT No.: PCT/KR2006/001193

§ 371 Date: Oct. 1, 2007

(30) Foreign Application Priority Data
Apr. 2, 2005 (KR) 10-2005-0027831
Jun. 3, 2005 (KR) 10-2005-0047902

(51) Int. Cl. C02F 1/68

(52) U.S. Cl. 204/674

(57) ABSTRACT

Disclosed is a silver ion water generating apparatus which can improve sterilizing and purifying forces even in a large water tank by widening the contact surface of silver as same weight increasing the amount of the generated silver ions, can be easily maintained by facilitating the exchange of a silver foam, and can prevent the silver ion water from not being properly generated due to the inferiority of current flow between the silver foam and the electrode terminal in use. The silver ion generating apparatus is consist of a water tank for storing water and positive and negative electrodes installed in the interior of the water tank. The positive electrode includes a silver foam in which open cells are formed. A plurality of conductive net bodies connected to an exterior positive electrode terminal are detachably installed in the interior of the water tank. Each silver foam is accommodated in the interior of the conductive net body.

### TECHNICAL FIELD

The present invention relates to a silver ion water generating apparatus, particularly to a silver ion water generating apparatus which can remarkably improve sterilizing and purifying forces even in a large water tank, can be easily maintained, and can prevent silver ions from not being properly generated due to inferiority of current flow between a silver foam and an electrode terminal.

### BACKGROUND ART

Conventionally, a silver ion generating apparatus which produces silver ion water by disposing electrode rod formed of silver in the water stored in a water tank and by applying a voltage to the electrode rod and electrolyzing silver has been circulated in the market. The silver ion generating apparatus has been widely used in facilities for purifying the water stored in a water tank or flowing water or in sterilizing facilities. FIG. 1 schematically shows the conventional silver ion water generating apparatus. The conventional silver ion water generating apparatus includes a water tank (110) for storing water, a pair of silver rods (115) installed in the interior of the water tank (110), and a positive electrode terminal (120) and a negative electrode terminal (125) which are electrically connected to the silver rods (115) respectively. In the apparatus, if positive and negative electric potentials are applied to the silver rods (115) by the electrode terminals (120) and (125) respectively, silver ions are generated from the silver rods (115) by the electrolysis reaction. Then, the generated silver ions are discharged into the water in the water tank and sterilizing germs in the water.

While the silver ion generating apparatus is effective in a small sized purifying system such as a domestic water purifier, the cost of silver is relatively high. Further, there is a limit in the surface area of the silver rod, it is not effective in a swimming pool or in an apparatus such as an industrial facility for purifying water of high capacity.

### DISCLOSURE OF THE INVENTION

Accordingly, it is the object of the present invention to provide a silver ion water generating apparatus which can improve sterilizing and purifying forces even in a large water tank by widening the contact surface of silver as same weight and increasing the amount of the generated silver ions and can be easily maintained by facilitating the exchange of a silver foam, and can prevent the silver ion water from not being properly generated due to the inferiority of current flow between the silver foam and the electrode terminal in use.

The foregoing and/or other objects of the present invention are achieved by providing a silver ion water generating apparatus comprising: a water tank (10) in which a hollow portion is formed in the interior thereof, an introducing opening through which water is introduced is formed on the one side surface thereof, and a discharging opening through which the introduced water is discharged is formed on the other side surface thereof; and a positive electrode and a negative electrode which are positioned in the hollow portion of the water tank (10), wherein the positive electrode includes a silver foam (20) in which silver forms open cells, one end of the negative electrode is electrically connected to a negative electrode terminal (7), and the silver foam formed of silver is electrolyzed to generate silver ions if a current is applied to the positive and negative electrodes position in the water tank (10).

The silver foam (20) positioned in the hollow portion of the water tank is positioned in an interior hollow portion of a conductive net body in which a conductive material forms a net-like shape, and the conductive net body is detachably mounted to the positive electrode terminal.

According to the present invention, an insertion hole penetrating through both ends of the silver foam is formed in the interior of the silver foam, a conductive electrode rod in which an expanding portion extends radially to the outside thereof is inserted into the circumferential portion of the insertion hole of the silver foam, the electrode rod is connected to the exterior positive electrode terminal, and a conductive spring resiliently supporting one end of the silver foam and the expanding portion of the electrode rod so that a current can flow between the silver foam and the electrode rod is interposed between the end of the silver foam and the expanding portion of the electrode rod.

Further, in the negative electrode, an insertion hole penetrating through both upper and lower ends of the silver foam is formed at an central portion the silver foam in which silver forms the open cells, a conductive electrode rod in which an expanding portion extends radially to the outside thereof is inserted into the circumferential portion of the insertion hole of the silver foam, the electrode rod is connected to the exterior negative electrode terminal, and a conductive spring resiliently supporting one end of the silver foam and the expanding portion of the electrode rod so that a current can flow between the silver foam and the electrode rod is interposed between the end of the silver foam and the expanding portion of the electrode rod.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a view for schematically showing the constitution of a conventional silver ion water generating apparatus;

FIG. 2 is a side cross-sectional view for showing a preferred embodiment of the present invention;

FIG. 3 is a front cross-sectional view of FIG. 2;

FIG. 4 is a side cross-sectional view for showing another preferred embodiment of the present invention; and

FIG. 5 is an exploded view for showing main parts of the preferred embodiment of FIG. 4.

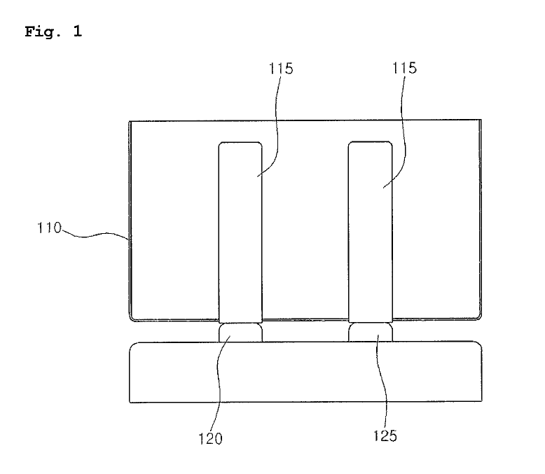

### BEST MODE FOR CARRYING OUT THE INVENTION

Hereinafter, preferable embodiments according to the present invention will be described with reference to the accompanying drawings. It should be noted that, in the drawings, the same elements are endowed with the same reference numerals.

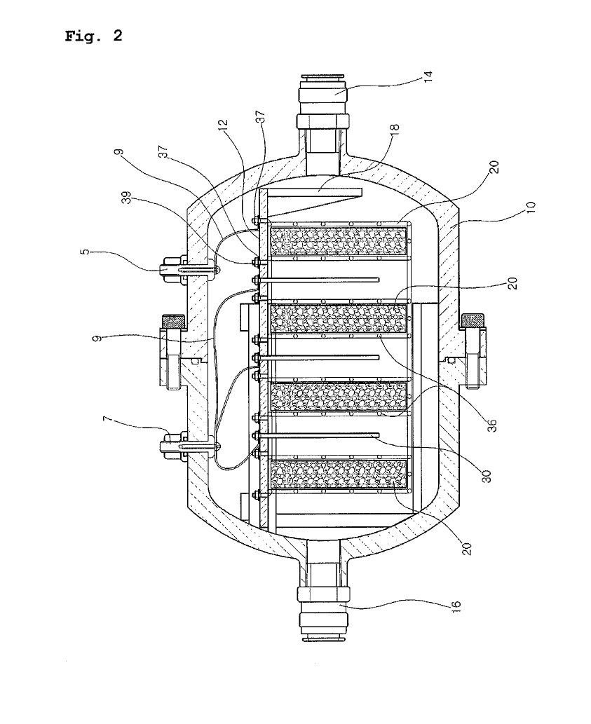

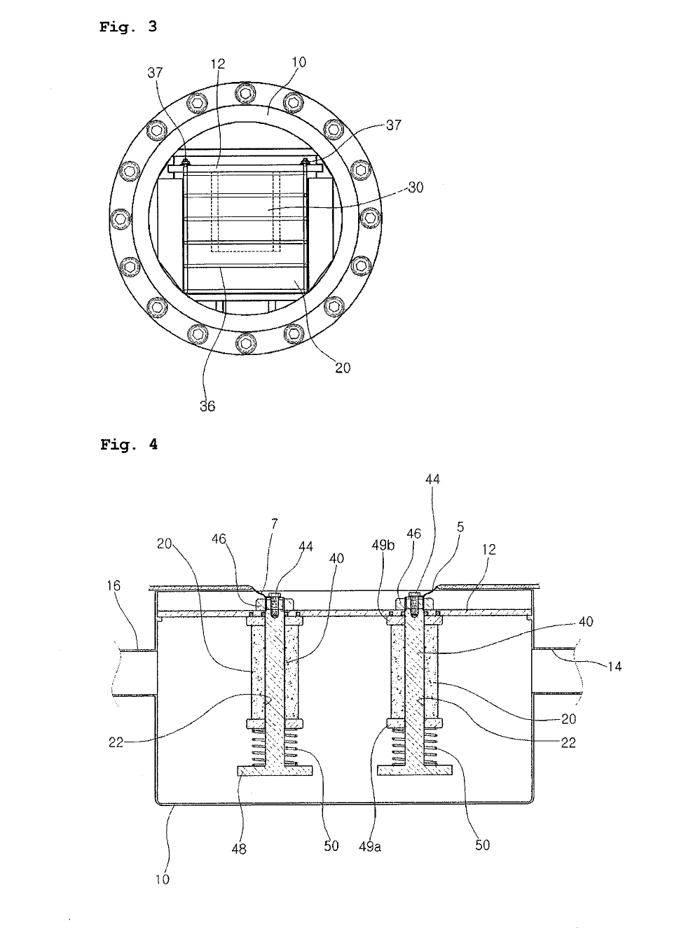

FIG. 2 is a side cross-sectional view for showing a preferred embodiment of the present invention, and FIG. 3 is a front cross-sectional view of FIG. 2. As shown in FIGS. 2 and 3, a positive electrode and a negative electrode are installed in the interior of a water tank (10) for storing water, and the positive electrode includes a silver foam (20) in which open cells are formed and silver ion water is generated by silver ions generated from the silver foam (20).

The water tank (10) has a box-like shape and is insulated. An insulated cover plate (12) is horizontally installed on the upper side of the interior of the water tank (10). An introducing opening (14) through which the original water is introduced and a discharging opening (16) through which the silver ion water is discharged are formed in both side walls of the water tank (10). A separation plate (18) is installed on the side of the introducing opening (14) in the interior of the water tank (10). The water introduced through the introducing opening (14) passes round the separation plate (18).

The silver foam (20) has a block-like shape in which open cells are formed, and is made of pure silver. The silver foam (20) is connected to the exterior positive electrode terminal (5) by the medium of a conductive net body (36) in order to constitute a positive electrode.

The cover plate (12) is horizontally installed on the upper side of the interior of the water tank (10). A plurality of rectangular conductive net bodies (36) are installed in the cover plate (12), and the silver foams (20) are accommodated in the conductive net bodies (36). Each conductive net body has a block-like shape, and one end thereof is opened. Preferably, the conductive net body (36) is formed of titanium dioxide. A bolt member (37) is provided at the opened end of each conductive net body (36). The bolt member (37) penetrates through the cover plate (12) and is engaged with a nut member (39). In this way, the plurality of conductive net bodies (36) are mounted to the cover plate (12).

Namely, the silver foam can independently connected to the positive electrode terminal to form a positive electrode, but it is preferable that the silver foam is detachably mounted into the interior of the conductive net body (36) to form a positive electrode.

Then, since the nut member (39) is engaged with the bolt member (37), with a wire (9) connected to the positive electrode terminal (5) being inserted between the nut member (39) and the cover plate (12), the conductive net body (36) can be connected to the positive electrode terminal (5). Further, since the silver foam (20) is accommodated in the interior of the conductive net body (36) so that currents can flow through the silver foam (20), the silver foam (20) forms the positive electrode. The silver foam (20) is disposed on the right and left sides of the water tank (10) so that the wider surface thereof faces the introducing opening (14) and the discharging opening (16). Therefore, when the water passes through the water tank (10), the contact area between the water and the silver foam (20) can become wider. Further, a plurality of electrode plates (30) are disposed in the water tank (10) so as to be located between the silver foams (20). Since the electrode plates (30) are connected to the wires (9) connected to the positive electrode terminal (7), they form the negative electrodes.

According to the preferred embodiment of the present invention, silver ions can be generated in the silver foams (20), which are positive electrodes and the water in the water tank can be changed to silver ion water by the principle of electrolysis. Then, since the water in the water tank makes contact not only with the surface of the silver foam (20) of sponge-type but also with through-holes in the silver foam (20) while passing through the through-holes, the contact area between the water and the silver is remarkably increases when compared with a conventional silver rod. Accordingly, since the generated amount of the silver ions increases due to the silver foam, the sterilizing and purifying forces in the water in a large purifying facility or a large water tank can remarkably increase.

Further, the sterilizing and purifying forces can remarkably increased even with silver of a same or lower weight, when compared with a silver rod. Furthermore, since the water passes round the separation plate (18) installed at the introducing opening (14) of the water tank (10), the stay time of the water becomes increasing. Therefore, since the water makes contact with the silver foam (20) more longer, the silver ion generating effect can increase.

Further, since the silver foam (20) is accommodated in the conductive net body (36) made of titanium dioxide and the conductive net body (36) is detachably mounted to the cover plate (12) in the water tank (10), when the silver foam (20) is exhausted due to the long time use, the conductive net body (36) can be separated and only the silver foam (20) can be promptly and easily exchanged.

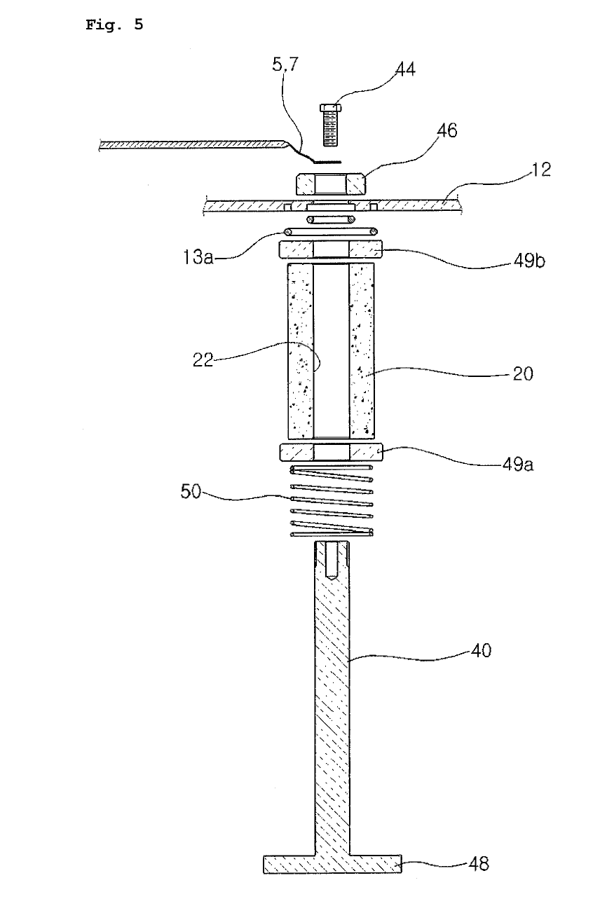

FIGS. 4 and 5 show another preferred embodiment of the present invention. Referring to FIGS. 4 and 5, a water tank (10) has a box-like shape and is insulated and the upper and lower portions of the water tank (10) are closed. An insulated cover plate (12) is horizontally installed on the upper side of the interior of the water tank (10). A pair of electrode rods (40) connected to a positive electrode terminal (5) and a negative electrode terminal (7) are disposed in the cover plate (12). A silver foam (20) is mounted onto a circumferential portion of each electrode rod (40) and a conductive spring (50) is interposed between the electrode rod (40) and one end of the silver foam (20).

The one end of the electrode rod (40) penetrates through the cover plate (12) and protrudes from the interior of the water tank (10) outside the cover plate (12). The positive electrode terminal (5) and the negative electrode terminal (7) are connected to upper end portions of the electrode rods (40) by bolts (44), respectively. A nut (46) is engaged with the circumferential portion of each electrode rod (40) protruding to the upper side of the cover plate (12), and the silver foams (20) and the electrode rods (40) are fixed to the cover plate (12) by the nuts (46). Further, an expanding portion (48) of flange-type is formed at a lower end portion of each electrode rod (40). The electrode rod (40) is formed of titanium dioxide, which is preferable since it is not rusted well when compared with a stainless steel and its electrical conductivity is good next to that of copper.

The silver foam (20) has a cylindrical shape of sponge-type, in which open cells are formed. An insertion hole (22) through which the upper and lower ends of the silver foam (20) is communicated is formed at a central portion of the silver foam (20). The circumferential portion of the electrode rod (40) is inserted into the insertion hole (22) of the central portion of the silver foam (20) so that the inner wall surface of the insertion hole (22) formed in the silver foam (20) makes contact with the circumferential portion of the electrode rod (40).

Further, washer members (49a) and (49b) are mounted to the upper end portions of each silver foam (20), respectively. The washer members (49a) and (49b) are ring-like shape, and preferably are formed of silver. A conductive spring (50) is interposed between the lower side washer member (49a) and an expanding portion (48) of the electrode rod (40). An upper end portion of the conductive spring (50) resiliently makes contact with the lower side washer member (49a) and a lower end portion thereof resiliently makes contact with the expanding portion (48) of the electrode rod (40), so that the lower end portion of the silver foam (20) and the lower side washer member (49a) and the expanding portion (48) of the electrode rod (40) resiliently make contact with each other. Namely, since the silver foam (20) and the electrode rod (40) always make contact with each other due to the resilient force of the spring (50), currents can constantly flow through the silver foam (20) and the electrode rod (40).

According to the preferred embodiment of the present invention, since the silver foam (20) is engaged with the circumferential portions of the electrode rod (40) and the conductive washer members (49a), (49b) and the conductive spring (50) are interposed between the silver foam (20) and the expanding portion (48) of the electrode rod (40) for the contact of the silver foam (20) and the electrode rod (40), the silver foams (20) are electrolyzed by positive and negative voltages applied from the electrode rods (40), with the silver foam (20) and the conductive electrode rods (40) always making contact with each other, thereby generating silver ions and sterilizing and purifying the water in the water tank (10).

Accordingly, since the water in the water tank (10) makes contact with the surfaces of the silver foams of sponge-type and also makes contact with the pores in the silver foams (20), the amount of silver ions generated by the silver foams increases. Further, since currents can constantly flow through the silver foams (20) and the electrode rods (40) due to the conductive springs (50) interposed between the expanding portions (48) of the electrode rods (40) and the ends of the silver foams (20), the electrical connections between the silver foams (20) and the electrode rods (40) can be effectively secured, even when the silver foams (20) are exhausted by a long time use.

On the other hand, since sealing members (13a) are provided at portions where the electrode rods (40) are engaged with the water tank (10), the water is prevented from being leaked between the water tank (10) and the electrode rods (40). Further, although FIGS. 4 and 5 show a constitution in which the positive and negative terminals are formed by inserting the silver foams (20) are inserted into the circumferential portions of the electrode rods (40) and the conductive springs (50) are interposed between the electrodes (40) and the one end portion of each silver foam (20), the negative terminal can employ a lead electrode, which is generally used in electrolysis.

According to the present invention, since the water in the water tank not only makes contact with the surfaces of the silver foams of sponge-type but also makes contact with the pores in the silver foams while passing through the pores, the contact area of the water and the silver remarkably increases, when compared with the conventional silver rod. Accordingly, the amount of silver ions generated by the silver foams increases and the sterilizing and purifying forces of the water in a large facility or water tank remarkably increase. Further, the sterilizing and purifying forces can remarkably increase even with silver of a same or lower weight, when compared with a silver rod. Further, since the silver foams are accommodated in the conductive net bodies formed of titanium dioxide, when the silver foams are exhausted due to the long time uses, the conductive net bodies can be separated and only the silver foams can be promptly and easily exchanged.

Further, since the silver foams are engaged with the circumferential portions of the electrode rods and the conductive water members and the conductive springs are interposed for the contacts of the silver foams and the electrode rods, silver ions can be generated by electrolyzing the silver foams, with the silver foams always making contact with the electrode rods, thereby sterilizing and purifying the water in the water tank. Accordingly, since currents can always flow through the silver foams and the electrode rods due to the conductive springs due to the electrical connections between the silver foams and the electrode rods, the silver ions are prevented from not being generated from the silver foams due to the inferiority of current flow in use.

Although a few embodiments of the present invention have been shown and described, it would be appreciated by those skilled in the art that changes might be made in this embodiment without departing from the principles and spirit of the invention, the scope of which is defined in the claims and their equivalents.

1. A silver ion water generating apparatus comprising:
a water tank (10) in which a hollow portion is formed in the interior thereof, an introducing opening through which water is introduced is formed on one side surface thereof, and a discharging opening through which the introduced water is discharged is formed on the other side surface thereof; and
a positive electrode and a negative electrode which are positioned in the hollow portion of the water tank (10),
wherein the positive electrode includes a silver foam (20) in which silver forms open cells, the one end of the negative electrode is electrically connected to a negative electrode terminal (7), and the silver foam (20) formed of silver is electrolyzed to generate silver ions if a current is applied to the positive and negative electrodes position in the water tank (10).

2. A silver ion water generating apparatus according to claim 1, wherein the silver foam (20) positioned in the hollow portion of the water tank (10) is positioned in an interior hollow portion of a conductive net body (36) in which a conductive material forms a net-like shape.

3. A silver ion water generating apparatus according to claim 2, wherein the conductive net body (36) is detachably mounted to the positive electrode terminal (5).

4. A silver ion water generating apparatus according to claim 1, wherein an insertion hole (22) penetrating through both ends of the silver foam (20) is formed in the interior of the silver foam (20), a conductive electrode rod (40) in which an expanding portion (48) extends radially to the outside thereof is inserted into the circumferential portion of the insertion hole (22) of the silver foam (20), the electrode rod (40) is connected to the exterior positive electrode terminal (5), and a conductive spring (50) resiliently supporting one end of the silver foam (20) and the expanding portion of the electrode rod (40) so that a current can flow between the silver foam (20) and the electrode rod (40) is interposed between the end of the silver foam (20) and the expanding portion (48) of the electrode rod (40).

5. A silver ion water generating apparatus according to claim 1, wherein, in the negative electrode, an insertion hole (22) penetrating through both upper and lower ends of the silver foam (20) is formed at an central portion the silver foam (20) in which silver forms the open cells, a conductive electrode rod (40) in which an expanding portion (48) extends radially to the outside thereof is inserted into the circumferential portion of the insertion hole (22) of the silver foam (20), the electrode rod (40) is connected to the exterior negative electrode terminal (7), and a conductive spring (50) resiliently supporting one end of the silver foam (20) and the expanding portion (48) of the electrode rod (40) so that a current can flow between the silver foam (20) and the electrode rod (40) is interposed between the end of the silver foam (20) and the expanding portion (48) of the electrode rod (40).
